(19) United States
(12) Patent Application Publication
(10) Pub. No.: US 2012/0040073 A1
(43) Pub. Date: Feb. 16, 2012

(54) INTERMEDIATE FOODSTUFF

(75) Inventors: Gerhard F. Fox, Neuenburg (DE); Hans-Ulrich Endress, Neuenburg (DE); Christine Rentschler, Pforzheim (DE)

(73) Assignee: HERBSTREITH & FOX KG, Neuenburg (DE)

(21) Appl. No.: 13/266,124

(22) PCT Filed: Apr. 23, 2009
(86) PCT No.: PCT/EP2010/002397

§ 371 Date: Oct. 24, 2011

(30) Foreign Application Priority Data
Apr. 23, 2009 (DE) 10 2009 018 369.8

(51) Int. Cl. A23L 1/05; A23L 3/3454; A23L 3/16; A23L 1/0534; A23L 1/0524

(52) U.S. Cl. 426/577; 426/573

(57) ABSTRACT

The invention relates to a foodstuff intermediate for producing a viscous to gelled foodstuff product by adding said intermediate to a flavour base and by processing using conventional household appliances. The intermediate comprises a household thickening agent with roughage consisting of predominantly insoluble vegetable fibre, mixed with a liquid such as water, milk or juice. The roughage is present in a quantity of between 0.1 and 10 wt % of the liquid and the foodstuff intermediate is packed into portions with a paste-like consistency.

The invention relates to an intermediate food product or foodstuff for producing a viscous to gelatinous food product by mixing it with a flavor base and processing it, in particular with the aid of commercially available household appliances such as kitchen appliances for private households. The flavor base is basically composed of a flavor precursor, for example consisting of fruits, vegetables, juices, milk or milk products, alcoholic beverages or a combination thereof and a flavoring admixture such as sugar or other sweeteners, salt, other seasonings or aromatic agents. The invention furthermore relates to a household thickening agent for producing the intermediate food product, respectively a food that is produced with the intermediate product, as well as a method for producing the food end product.

Intermediate food products containing household thickening agents are in widespread use, in particular for the production of marmalades, jams, jellies and other fruit preparations. Gelling powder and gelling sugar are primarily used for this and are composed, among other things, of sugar such as sucrose or fructose, a gelling agent such as pectin, carrageen, xanthan gum, carob bean gum or a combination thereof as well as a gelling aid, for example fruit acid or a combination of a fruit acid and a salt of a fruit acid.

Gelling sugars contain the total amount of sugar that is required for the fruit preparation. When using gelling powders, the required amount of sugar for the gelling is added separately.

Gelling sugar and gelling powder are sold commercially for producing fruit preparations at home, using different dry substances. The traditional gelling sugar is used at a ratio of 1:1 with the fruit mixture to be processed. In addition, other types of gelling sugars are commercially available which are processed, for example, at a ratio of 3:1 or 2:1 of fruit mixture to the weight of the respective gelling sugar. Gelling powders are furthermore also commercially available which are mixed with a predetermined amount of sugar, for example at a ratio of 1:1, 2:1 or 3:1 of fruit mixture to gelling powder-sugar-mixture.

In each case, the user must adhere relatively precisely to the predetermined weight ratios between the fruit mixture and the gelling sugar, respectively the mixture of gelling powder and sugar, to obtain the desired consistency for the food end product. A simple multiplication of the recipe using the same cooking time is not possible when using gelling sugar, respectively gelling powder.

For the at home production of fruit preparations, involving different amounts of dry matter, high-esterified pectins are generally used if the dry matter share is high and low-esterified or low-esterified, amidized pectins are used as gelling agents if the dry matter share to be processed is low.

Depending on the type of household thickening agent used, this agent may only be usable for a specific dry matter range, for example amounting to 50 to 70%, 30 to 50 or also 10 to 40% of the total material of the end product.

Buffering agents, such as fruit acid or salts of the fruit acid, must frequently be added to the known gelling sugars or gelling powders to balance the different acid contents, respectively buffer capacities, of the fruit mixtures to be processed and to reach the optimum gelling range for the respective gelling agent.

When using these gelling sugars or gelling sugar/gelling powder mixtures as intermediate food products, the viscosity reached during the cooking of the flavor base to be processed is frequently already high enough so that the product can easily burn or splatter which, in turn, results in a difficult or uncomfortable processing.

The poster entitled “Functional Properties of Herbacel AQ Plus Fruit Fibres” published by the company Herbafood Ingredients GmbH, D-14542, Werder, Germany for the “Dietary Fibre 2000” Conference on May 13 to 18, 2000, in Dublin, Ireland, describes the properties of the insoluble fruit fibers marketed under the brand name “Herbacel AQ Plus.” To demonstrate the gelling properties of the aforementioned fibers, an orange juice mixture with a 2% share of the fibers is shown in a homogenized as well as a non-homogenized state.

The document EP 1 458 244 B1 describes a kit for the instant production of a spreadable emulsion comprising oil and water. The kit contains an oil phase, stored in a separate packaging unit, which comprises a cold hydrating thickening agent. Insoluble plant fibers corresponding to the product marketed as “Herbacel AQ Plus” constitute the additional or alternative material to the cold hydrating thickening agent.

The company publication entitled “KONFITÜREN 55° BRIX” by the company Herbstreith & Fox, D-75305 Neuenbürg, Germany, contains several recipes for fruit preparations which use a pectin solution.

A recipe for a strawberry sorbet is known from the publication entitled “VERBESSERTE FRUCHTFASERN FÜR DIE MODERNE LEBENS-MITTELVERARBEITUNG” [Improved Fruit Fibers for Modern Food Processing] by the company Herbafood Ingredients GmbH, D-14542 Werder, Germany. This recipe uses a 1% share of citrus fibers marketed under the brand name “Herbacel AQ Plus.”

A different recipe for a dietary fiber-containing dessert can be found in the publication entitled “Fruit and More” by the company Herbafood Ingredients GmbH, D-14542 Werder, published in the publication “FLÜSSIGES OBST” [Liquid Fruit] May 2002, wherein this recipe contains a 2% share of the insoluble citrus fiber marketed under the brand name “Herbacel AQ Plus.”

The article “Structuring of Low Calorie Food with Fruit Fibres” by J. Fischer in “Gums and Stabilisers for the Food Industrie 14,” published in “RSC Publishing” of the Royal Society of Chemistry in 2008, describes the pre-treatment of the insoluble citrus fiber material marketed under the brand name “AQ plus” by dispersing it in water and simultaneously admitting it with shearing forces.

The information published Dec. 22, 2008 by the company Hawkins Watts Australia Pty Ltd on the Internet shows a recipe as well as a method for producing a jam or marmalade with pectins representing the primary dietary fiber material.

It is the object of the invention to provide an intermediate food product which avoids the aforementioned disadvantages and permits an easy and flexible production of food products at home.

This object is solved with an intermediate food product having the features as disclosed in claim 1. The intermediate food product contains a household thickening agent containing dietary fiber or roughage primarily composed of insoluble plant fibers, such as the ones described in the document WO 01/17376 A1. In addition, the household thickening agent is also mixed with liquid, in particular water, milk or juice. The amount of the dietary fiber in this case ranges from 0.1 to 10.0 weight %, relative to the weight of the liquid. The intermediate food product is present in the form of a paste-like consistency. An intermediate food product of this type allows an extremely variable selection with respect to the share of the flavor base to be processed and, in particular, with respect to the ratio of the flavor base to the added flavoring agent, in particular sugar, wherein this recipe can simply be multiplied. In addition, one and the same intermediate food product can be used to produce different food end products for which the amount of dry matter relative to the total weight of the food product can range from 5 to 70%. A plurality of products in a private household setting can thus be produced easily and with the desired consistency, in particular fruit preparations which can be rather sweet or rather fruity, but also totally unsweetened food products. For all planned products, this can be achieved using only a single intermediate food product. The intermediate food product having a paste-like consistency can already be packaged pre-portioned or can be produced especially easily by mixing the pre-portioned and packaged household thickening agent with a predetermined amount of liquid. In this way, the intermediate food product is made available in a ready to use form, resulting in a very convenient processing.

An intermediate food product of this type can furthermore simply be mixed into the respective flavor base, independent of a cooking step, to obtain the desired consistency. The flavor base for the production of marmalade or jam, for example, can initially be boiled without the household thickening agent and can be mixed with this thickening agent after the cooking step, thereby reducing the danger of boiling over, burning or splattering as a result of excess viscosity during the cooking step.

The intermediate food product can also be stirred in while cold, thus making it possible to produce fruit preparations or fruit sorbets, for example, without a cooking operation.

A desired consistency of the food product to be prepared can be obtained with particular reliability when using a particularly preferred amount of dietary fiber in the intermediate food product, ranging from 1.0 to 7.0 weight % relative to the weight of the liquid.

The liquid and the dietary fiber material are furthermore advantageously processed by admitting them with shearing forces. The swelling capacity of the dietary fiber can be increased further in this way and the paste-like consistency can be produced which, in turn, results in achieving a smooth structure for the food end product to be produced. As a result, the product leaves a good taste in the mouth during the consumption.

The dietary fiber material of a particularly favorable embodiment consists of fruit, vegetable and/or cereal fibers, in particular insoluble citrus and/or apple fibers. As a result, the dietary fiber material or household thickening agent can have an especially high water-binding capacity.

In addition to the fruit, vegetable and/or cereal fibers of the household thickening agent, it can furthermore be advantageous to mix at least one additional dietary fiber material that differs from the plant fibers into the intermediate food product, e.g. soluble fibers and in particular pectin or inulin. The food end product to be produced can thus be enriched with additional dietary fiber material.

A preservative is advantageously added to the intermediate food product. The preservative can be measured so as to ensure solely the preservation of the intermediate food product. Alternatively, an amount of the preservative can be added which is also suitable for preserving the food end product, produced by using intermediate food product that is provided.

The object is furthermore solved with a food end product which is produced using the intermediate food product in one of the above-mentioned forms, wherein this food end product contains a flavor base which primarily consists of fruits, vegetables, juices, milk or milk products or alcoholic beverages such as beer, wine or champagne, or combinations thereof. Furthermore added is an added flavoring agent, for example sweeteners and in particular sugar, fructose, saccharine or honey, or other types of seasonings such as aromatic agents and spices. As a result, it is possible to produce a plurality of food products with a desired consistency at home.

The flavor base in that case is advantageously a fruit mixture and the added flavoring agent is sugar, thereby making it particularly easy to adjust the consistency of a food end product, meaning a fruit preparation such as marmalade, jam, fruit spread or fruit jelly.

The food end product advantageously has a content of 20 to 40 weight % of the intermediate food product, 30 to 80 weight % of the flavor base and 0 to 50 weight % of the added flavoring agent. With these weight shares, it is particularly easy to obtain the desired consistency for the food end product.

It is particularly advantageous in that case to have a total content of at least 3 weight % of the dietary fiber material and the additional dietary fiber material, wherein it is also possible to provide only the dietary fiber material. In each case, a food product which is “enriched with dietary fiber material” is obtained.

According to a different advantageous embodiment, admixtures such as preservatives are added with a maximum content of 1 weight %, so as to improve in particular the shelf life or durability of the food end product. On the other hand, buffer materials and in particular fruit acids or salts of fruit acids can also be omitted completely. However, these buffer materials can be added to improve the flavor. This object is furthermore solved with a method for producing food products according to one of the above-mentioned embodiments. With this method, the basic flavoring agent and the added flavoring agent are mixed in a first step into the flavor base. The household thickening agent is furthermore pre-portioned and packaged in the dry form, such that it can be mixed with the liquid, in particular water, milk or juice at a predetermined weight ratio. The amount of liquid which is suitable in view of the pre-portioned amount of the household thickening agent is listed on the packaging. As a result, the intermediate food product itself can easily be produced at home, in particular when using commercially available household appliances. It is furthermore possible to mix the household thickening agent directly with a fruit mixture to be processed, especially without previously mixing it with liquid to form a paste-like consistency, wherein the amount of the fruit mixture suitable for use should also be listed. In addition, it is favorable if the pre-portioned amount of the household thickening agent is packaged in a pourable form. The pourable consistency in this case permits a simple pre-portioning as well as easy handling during the processing of the household thickening agent. In a subsequent step, the pre-portioned intermediate food product is stirred into the flavor base. This use of the pre-portioned intermediate food product makes it particularly easy to produce the various recipes and to obtain a desired consistency for the food end product to be produced. It is advantageous if the intermediate food product, before being used, is produced by mixing the household thickening agent with liquid at a predetermined mixing ratio and by pre-treating it, for example with the aid of a commercial household appliance such as a stirring, mixing, or cutting device or with the aid of a homogenizer. A particularly high swelling capacity of the intermediate food product can thus be achieved.

Following the first step, it is furthermore advantageous if the flavor base is boiled during a subsequent step, among other things to completely dissolve the sugar and to ensure a certain amount of durability.

Following the mixing of the intermediate food product into the flavor base, the next step advantageously involves providing the product with a longer shelf life, so as to improve the storage capacity of the food end product.

A preservative is therefore advantageously added which improves the shelf life and durability, thereby making it especially easy and quick to carry out this step for improving the shelf life.

It is furthermore advantageous if the food end product is heated briefly to improve the shelf life and durability, thus making possible a preservation of the product without adding non-natural materials.

The following are examples of recipes for producing the intermediate food product according to the invention, respectively for producing the food end product, using household thickening agents:

### 1) The Intermediate Food Product

20 g of the dietary fiber material according to the document WO 01/17376 (for Example “Herbacel AQ Plus Citrusfaser” by the company Herbstreith & Fox KG Pektin-Fabriken) and, if applicable, a soluble fiber admixture.
300 g water

The intermediate food product can be packaged in a ready-for-use paste-like form, wherein the dietary fiber and the liquid in the form of water can be pre-treated by admitting them with shearing forces. Besides the listed amounts, the intermediate food product or the household thickening agent can of course also be pre-portioned in different amounts which are suitable for household use. The shelf life or durability can furthermore be improved through the use of preservatives, pasteurizing, heating, or any other known and suitable type of preservation.

Alternatively, the household thickening agent can be packaged in the dry state and thus the pourable form, so that it can be mixed with water to form the intermediate food product or that it can be mixed directly into the flavor base to be processed. The packaging in that case should list the ratio at which the household thickening agent should be mixed in or the amount of water to be mixed in for producing the intermediate food product. We can furthermore point to a pre-treatment of the mixture with the aid of a stiffing, mixing or cutting device to improve the properties of the intermediate food product.

### 2) The Food End Product in the Form of a Fruit Preparation

320 g of the intermediate food product
400 g of the fruit mixture
400 g of sugar
   The production process takes place as follows:

The fruit mixture as flavor base is mixed with the sugar, constituting the added flavoring agent, and is cooked for at least 3 minutes. Finally, the intermediate food product prepared as disclosed in Point 1) is added and is stirred in for approximately 1 minute. To achieve a better shelf life, admixtures such as preservatives can be added, for example at a share of 1.0 weight % of the food product. Alternatively or in addition, the food product can be heated once more, for example on a stove or in the microwave, to ensure a desired minimum shelf life. Following this, the food end product can be filled into containers.

### 3) The Food Product in the Form of a Fruit Sorbet

320 g of the intermediate food product
800 g pureed food
200 g sugar
   The product is produced as follows:

The pureed fruit as basic material is mixed with the sugar in the form of the added flavoring agent to form a flavor base. This is followed by a short dwell time to allow the sugar to dissolve. Alternatively or additionally, the flavor base can also be heated. The intermediate food product according to Point 1) is then mixed in, preferably in the cold state. In the following step, the resulting mixture is cooled to a temperature of approximately −10° C., thereby resulting in a food product in the form of a fruit sorbet which can then be stored in a freezer to preserve it.

In addition to the flavor base consisting of a fruit mixture, a corresponding or similar recipe and method of producing the food end product with the household thickening agent according to the invention, as disclosed in Points 2) or 3), can also be used for all other flavor base materials, such as vegetables, juices, milk or milk products, alcoholic beverages or a combination thereof and/or for all other added flavoring agents intended for use, such as salt or other seasonings.

1. An intermediate food product for producing a viscous to gel-type food end product by mixing it into a flavor base and processing it with the aid of a commercially available household appliance, comprising
a household thickening agent composed of a dietary fiber material that mainly consists of insoluble plant fibers and is mixed with water, milk or juice;
wherein the amount of dietary fiber provided corresponds to 0.1 to 10 weight % of the liquid, and
the intermediate food product is packaged pre-portioned and has a paste-like consistency.

2. The intermediate food product according to claim 1, characterized in that the share of the dietary fiber material amounts to 1.0 to 7.0 weight % of the liquid.

3. The intermediate food product according to claim 1, characterized in that the liquid and the dietary fiber material are pretreated by subjecting them to shearing forces.

4. The intermediate food product according to claim 1, characterized in that the dietary fiber material is composed of plant fibers such as fruit, vegetable and/or cereal fibers.

5. The intermediate food product according to claim 4, characterized in that at least one additional dietary fiber material that differs from the plant fibers is added.

6. The intermediate food product according to claim 1, characterized in that a preservative is added.

7. A food end product which is produced by using the intermediate food product according to claim 1, characterized in that the flavor base comprises:
a basic flavor material of primarily fruits, vegetables, milk and milk products, juices or alcoholic beverages such as beer, wine or champagne, or a combination thereof, as well as an additional flavoring agent such as sweeteners or seasoning agents or aromatic agents.

8. The food end product according to claim 7, characterized in that the basic flavor material is a fruit mixture and that the added flavoring agent is sugar.

9. The food end product according to claim 7, characterized in that it is composed of the following:
20 to 40 weight % of the intermediate food product
30 to 80 weight % of the basic flavor material and
0 to 50 weight % of the added flavoring agent.

10. The food end product according to claim 7, characterized in that the dietary fiber material and the additional dietary fiber material are present in a total amount of at least 3 weight %.

11. The food end product according to claim 7, characterized in that the added flavoring agents take up a maximum share of 1 weight %.

12. A method for the at home production of a food end product according to claim 7, for which:
in a first step, the flavor base and the added flavoring agent are mixed to form the basic flavor material and
the intermediate food product is produced by mixing a household thickening agent with liquid at a predetermined mixing ratio, wherein the household thickening agent to be mixed with the liquid at a predetermined weight ratio is packaged in pre-portioned amounts and in a pourable form, with a corresponding dry weight and listing the liquid amount to be used, and
the intermediate food product is pretreated by admitting it with the aid of a stirring, mixing or cutting device or with a homogenizers, and
that in a following step, the pre-portioned intermediate food product is stirred into the flavor base.

13. The method according to claim 12, characterized in that following the first step, the flavor base is boiled in a following step.

14. The method according to claim 12, characterized in that after mixing the intermediate food product into the flavor base, the product is then preserved in a following step.

15. The method according to claim 14, characterized in that preservatives are added in order to preserve the product.

16. The method according to claim 14, characterized in that the food end product is heated to preserve it.

17. The intermediate food product according to claim 2, characterized in that the liquid and the dietary fiber material are pretreated by subjecting them to shearing forces.

18. The intermediate food product according to claim 17, characterized in that the dietary fiber material is composed of plant fibers such as fruit, vegetable and/or cereal fibers.

19. The intermediate food product according to claim 3, characterized in that the dietary fiber material is composed of plant fibers such as fruit, vegetable and/or cereal fibers.

20. The intermediate food product according to claim 2, characterized in that the dietary fiber material is composed of plant fibers such as fruit, vegetable and/or cereal fibers.
